(19) United States
(12) Patent Application Publication
(10) Pub. No.: US 2026/0189538 A1
(43) Pub. Date: Jul. 2, 2026

(54) SYSTEM AND DEVICE FOR ENHANCING SECURITY OF CONTROLLER AREA NETWORK

(71) Applicant: 42dot Inc., Seongnam (KR)

(72) Inventors: Geun Yong Yun, Seongnam (KR); Heung Sik Eom, Seongnam (KR); Jong Bum Lim, Seongnam (KR)

(21) Appl. No.: 19/431,319

(22) Filed: Dec. 23, 2025

(30) Foreign Application Priority Data
Dec. 30, 2024 (KR) 10-2024-0200464

(51) Int. Cl. H04L 9/40; H04L 9/08; H04L 9/32

(52) U.S. Cl. CPC H04L 63/0428; H04L 9/0833; H04L 9/3242

(57) ABSTRACT

Provided are a system and method for enhancing security of a controller area network (CAN). The system may include a CAN gateway and a plurality of CAN nodes, wherein the CAN gateway and the plurality of CAN nodes are configured to transmit and receive, through a CAN bus, a CAN message divided into a plurality of fields, the CAN message includes a secure CAN message, and a data field of the secure CAN message is an encrypted data field.

### CROSS-REFERENCE TO RELATED APPLICATION

This application is based on and claims priority under 35 U.S.C. § 119 to Korean Patent Application No. 10-2024-0200464, filed on Dec. 30, 2024, in the Korean Intellectual Property Office, the disclosure of which is incorporated by reference herein in its entirety.

### BACKGROUND

### 1. Field

The present disclosure relates to a system and device for enhancing security of a controller area network.

### 2. Description of the Related Art

The existing controller area network (CAN) protocol provides efficient in-vehicle communication, but has many vulnerabilities due to the absence of basic security features.

In particular, the CAN protocol lacks mechanisms for message authentication, confidentiality protection, and integrity verification, and thus lacks defense against unauthorized access and data tampering. Due to this, the risk of various cyber attacks, such as replay attacks or spoofing attacks, is increasing.

To solve these problems, there is a growing need for a CAN protocol with improved security features.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### SUMMARY

The present disclosure provides a system and device for enhancing security of a controller area network. Objectives of the present disclosure are not limited to the foregoing, and other unmentioned objectives or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

According to a first aspect of the present disclosure, a system for enhancing security of a controller area network (CAN) includes a CAN gateway and a plurality of CAN nodes, wherein the CAN gateway and the plurality of CAN nodes are configured to transmit and receive, through a CAN bus, a CAN message divided into a plurality of fields, the CAN message includes a secure CAN message, and a data field of the secure CAN message is an encrypted data field.

According to a second aspect of the present disclosure, a method of enhancing security of a CAN includes encrypting a data field of a seed CAN message based on a master key provided for each vehicle, and transmitting the seed CAN message including the encrypted data field to a plurality of CAN nodes through a CAN bus, wherein the data field of the seed CAN message includes an initial seed value, a freshness value (FV), and a message authentication code (MAC).

According to a third aspect of the present disclosure, there may be provided a computer-readable recording medium having recorded thereon a program for causing a computer to execute the method according to the second aspect.

In addition, other methods and systems for implementing the present disclosure, and a computer-readable recording medium having recorded thereon a computer program for executing the methods may be further provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a controller area network (CAN) system according to an embodiment of the present disclosure;

FIG. 2 is a diagram illustrating a connection relationship among a CAN gateway, CAN nodes, and CAN buses, according to an embodiment;

FIGS. 3A to 3D are diagrams for describing structures of CAN messages, according to an embodiment;

FIG. 4 is a diagram illustrating an example of transmitting CAN messages from a CAN gateway to CAN nodes, according to an embodiment;

FIG. 5 is a diagram for describing a process of generating a group session key, according to an embodiment;

FIGS. 6A and 6B are diagrams illustrating examples of a secure CAN message in which a data field is encrypted;

FIGS. 7A and 7B are diagrams for describing structures of encrypted data fields in secure CAN messages, according to an embodiment;

FIG. 8 is a diagram for describing a process of generating and verifying a secure CAN message, according to an embodiment;

FIGS. 9A and 9B are diagrams for describing a method of using a group session key statically or dynamically, according to an embodiment;

FIG. 10 is a flowchart of a method of enhancing security of a CAN, according to an embodiment; and

FIG. 11 is a block diagram of a CAN gateway device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the accompanying drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. The singular expression also includes the plural meaning as long as it is not inconsistent with the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the present disclosure will be described in detail with reference to the accompanying drawings.

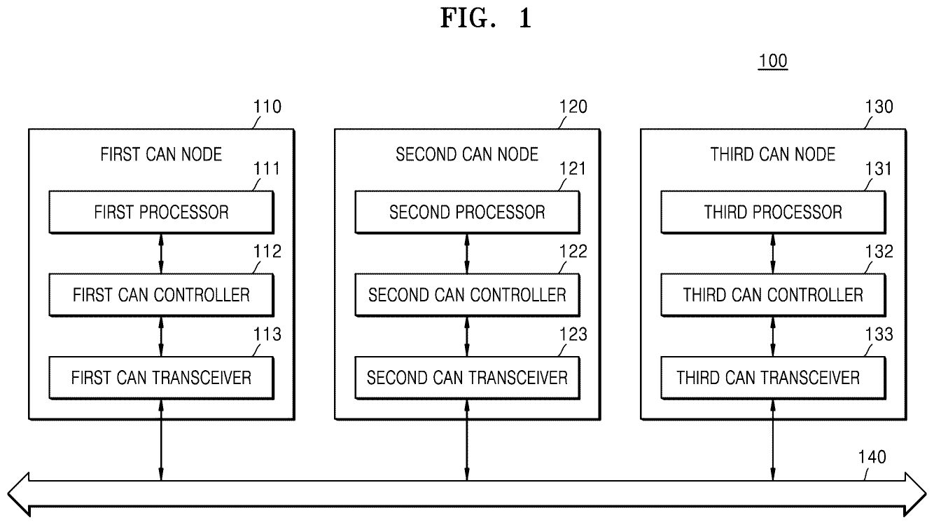

FIG. 1 is a block diagram of a controller area network (CAN) system according to an embodiment of the present disclosure.

A CAN system 100 may be a system that performs communication according to any one of CAN 2.0 A, CAN 2.0 B, CAN-FD, and Extended CAN-FD protocols to be described below.

Referring to FIG. 1, the CAN system 100 may include first to third CAN nodes 110, 120, and 130, and a CAN bus 140. Although three CAN nodes are illustrated by way of example, the number of CAN nodes is not limited thereto. A CAN node may be referred to as an electronic control unit (ECU). The CAN system 100 may be applied to various fields using a CAN protocol. For example, the CAN system 100 may be a vehicle system.

The first CAN node 110 includes a first processor 111, a first CAN controller 112, and a first transceiver 113. The second CAN node 120 includes a second processor 121, a second CAN controller 122, and a second transceiver 123. The third CAN node 130 includes a third processor 131, a third CAN controller 132, and a third transceiver 133.

Each of the first to third CAN nodes 110, 120, and 130 is connected to the CAN bus 140 to perform communication. For example, in a case in which the CAN system 100 is a vehicle system, each of the first to third CAN nodes 110, 120, and 130 may be a device for electronically controlling various vehicle apparatuses such as an engine, a steering wheel, or brakes.

The first to third processors 111, 121, and 131 may perform functions of a central processing unit (CPU) for the corresponding CAN nodes.

For example, in a case in which the first CAN node 110 is an ECU for controlling an engine, the first processor 111 may perform control operations and calculation operations required to control the engine. The first processor 111 may provide information generated by the control operations and the calculation operations to the first CAN controller 112 as a transmission signal.

For example, the first processor 111 may receive, from the first CAN controller 112, information generated by the second processor 121 or the third processor 131. Accordingly, the CAN node may interact with other CAN nodes, and complex functions such as autonomous driving may be performed through the interaction.

The first to third CAN controllers 112, 122, and 132 control transmission and reception of information for the corresponding CAN nodes. Each of the first to third CAN controllers 112, 122, and 132 provides information including identification data to the CAN bus 140. Each of the first to third CAN controllers 112, 122, and 132 analyzes identification data of information provided to the CAN bus 140 to determine whether to receive the information.

The identification data indicates an attribute of the corresponding information, and each of the first to third CAN controllers 112, 122, and 132 may determine, based on the identification data, whether the information is required for driving the corresponding CAN node.

Each of the first to third CAN controllers 112, 122, and 132 may integrally support various CAN protocols. In addition, each of the first to third CAN controllers 112, 122, and 132 may detect a load of the corresponding processor among the first to third processors 111, 121, and 131 or a load of the CAN bus 140, to overwrite transmission information or reception information with the latest data. Accordingly, the efficiency of the CAN system 100 may be ensured, and transmission delay of information due to load may be prevented, thereby securing stability. Details of overwriting the transmission information or the reception information will be described below.

The first to third transceivers 113, 123, and 133 receive transmission information from the first to third CAN controllers 112, 122, and 132, respectively, and transmit the transmission information to the CAN bus 140. In addition, the first to third transceivers 113, 123, and 133 receive reception information from the CAN bus 140, and transmit the reception information to the first to third CAN controllers 112, 122, and 132, respectively.

The first to third transceivers 113, 123, and 133 may set a protocol in advance. The first to third transceivers 113, 123, and 133 may transmit transmission information to the CAN bus 140 and receive reception information from the CAN bus 140, according to the set protocol. The protocol may be any one of CAN 2.0 A, CAN 2.0 B, CAN-FD, and Extended CAN-FD protocols, but is not limited thereto. The first to third transceivers 113, 123, and 133 may support all CAN communication protocols, and may select a protocol determined according to a vehicle system.

The CAN bus 140 may provide a communication path between the first to third CAN nodes 110, 120, and 130 of the CAN system 100. The first to third CAN nodes 110, 120, and 130 may exchange information with each other through the CAN bus 140. When using the CAN bus 140, information is exchanged without directly connecting the CAN nodes to each other, and thus, efficiency may be secured in terms of connection complexity, cost, and weight between the CAN nodes.

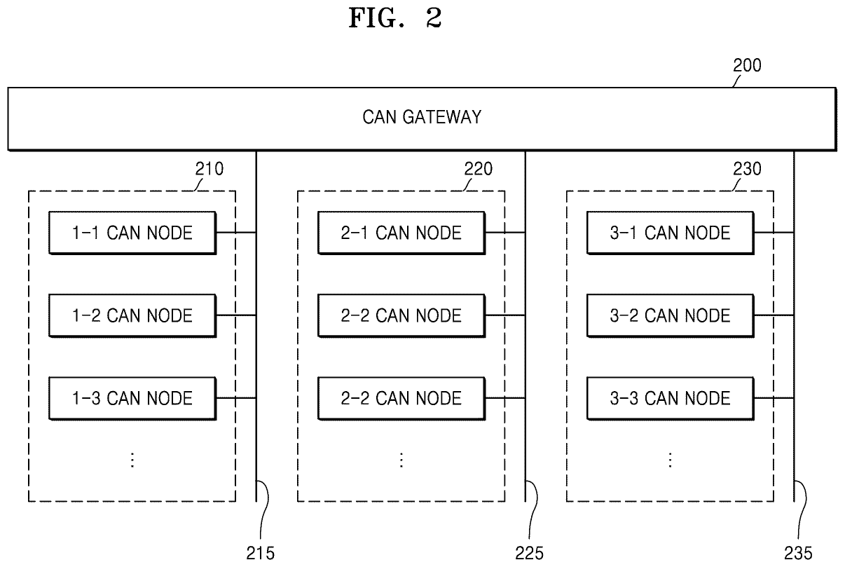

FIG. 2 is a diagram illustrating a connection relationship among a CAN gateway, CAN nodes, and CAN buses, according to an embodiment.

A CAN system may include a CAN gateway 200, a plurality of CAN nodes, and CAN buses 215, 225, and 235. At least some of the plurality of CAN nodes may be grouped to form CAN node groups 210, 220, and 230. Although FIG. 2 illustrates three CAN node groups 210, 220, and 230 by way of example, the number of CAN node groups is not limited thereto.

For example, the first CAN node group 210 may include engine-related CAN nodes, wherein a 1-1 CAN node may be a transmission-related CAN node, and a 1-2 CAN node may be a battery-related CAN node. For example, the second CAN node group 220 may include brake-related CAN nodes, wherein a 2-1 CAN node may be a suspension-related CAN node, and a 2-2 CAN node may be a steering-related CAN node. For example, the third CAN node group 230 may include lighting-related CAN nodes, wherein a 3-1 CAN node may be a seat-related CAN node, and a 3-2 CAN node may be a rear-related CAN node.

The CAN gateway 200 may be connected to a plurality of CAN nodes included in a specific CAN node group via a CAN bus. Referring to FIG. 2, the CAN gateway 200 may transmit and receive CAN messages to and from the first CAN node group 210 through the first CAN bus 215, may transmit and receive CAN messages to and from the second CAN node group 220 through the second CAN bus 225, and may transmit and receive CAN messages to and from the third CAN node group 230 through the third CAN bus 235.

The CAN gateway 200 may perform routing. Routing refers to an operation of transmitting a message and data from one communication bus to another communication bus. The CAN gateway 200 may transmit and receive CAN messages between buses of the same type. For example, the CAN gateway 200 may transmit and receive CAN messages between buses of different types.

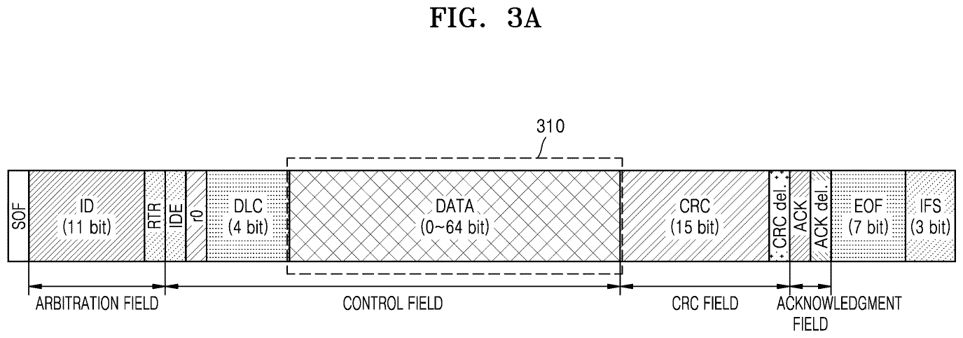

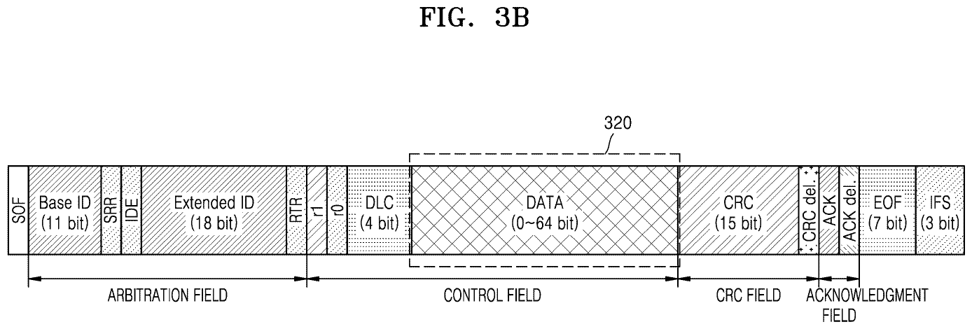

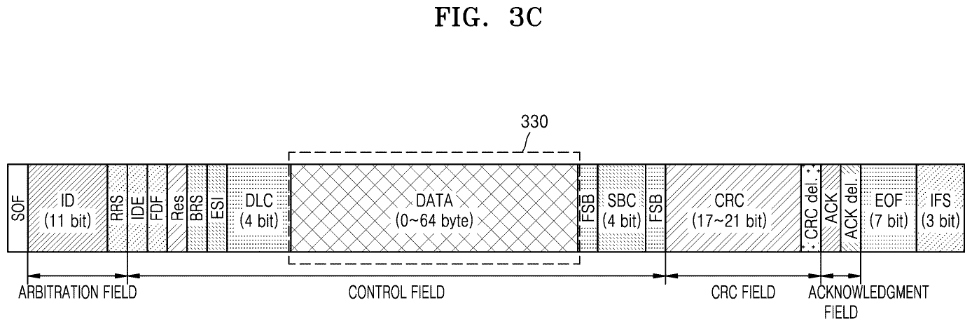

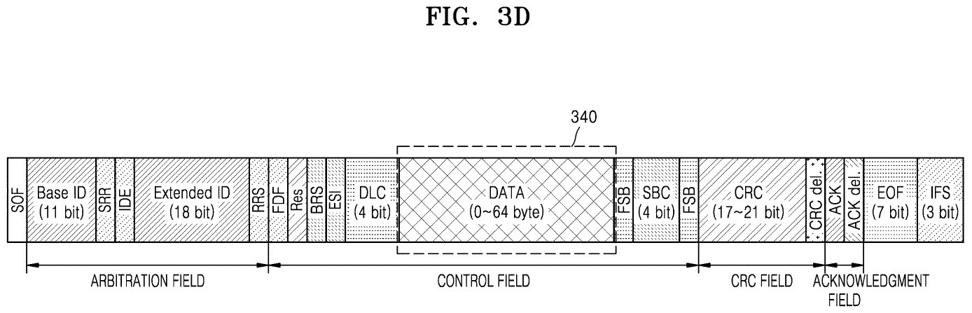

FIGS. 3A to 3D are diagrams for describing structures of CAN messages, according to an embodiment.

FIG. 3A illustrates a structure of a CAN message for the CAN 2.0 A protocol.

The CAN message for the CAN 2.0 A protocol is divided into a start frame (Start), an arbitration field, a control field, a data field, a cyclic redundancy check (CRC) field, an acknowledgment field, and an end frame (End).

The arbitration field may include 11-bit identification data (ID) and a 1-bit remote transmission request (RTR). The identification data (ID) may indicate an attribute of the CAN message. The priority of the CAN message may be determined based on the identification data (ID). For example, the priority of the CAN message may be set to be higher as the value of the identification data (ID) decreases. The RTR is used to determine a data frame and a remote frame, and may have a bit value of 0 for a data frame.

The control field may include a 1-bit identifier extension (IDE), one reserved bit, and a 4-bit data length code (DLC). The IDE may be used to indicate the CAN 2.0 A protocol having 11-bit identification data (ID), and may have a bit value of 0. The DLC may be used to indicate the length of the data field. In the CAN 2.0 A protocol, a data field may have a length of 0 bits to 64 bits.

The CRC field may include a 15-bit CRC and a 1-bit CRC delimiter. The CRC may be used to detect an error through a cyclic redundancy check (CRC). The CRC delimiter may be provided to distinguish the CRC field from the acknowledgment field, and may have a bit value of 1.

The acknowledgment field may include a 1-bit acknowledgment and a 1-bit acknowledgment delimiter. The acknowledgment may be set to have a bit value of 1 for transmission information and provided to the CAN bus. The acknowledgment may be set to have a bit value of 0 when reception information is received without errors. The acknowledgment delimiter may be provided to distinguish the acknowledgment field from the end frame, and may have a bit value of 1.

FIG. 3B illustrates a structure of a CAN message for the CAN 2.0 B protocol.

The CAN message for the CAN 2.0 B protocol is divided into a start frame (Start), an arbitration field, a control field, a data field, a CRC field, an acknowledgment field, and an end frame (End).

The arbitration field may include 11-bit first identification data (ID1), a 1-bit substitute remote request (SRR), a 1-bit IDE, 18-bit second identification data (ID2), and a 1-bit RTR. The first identification data (ID1) and the RTR perform the same functions as the identification data (ID) and the RTR of FIG. 3A. The SRR and the IDE may be provided to distinguish from the CAN 2.0 A protocol, and may have a bit value of 1.

The control field may include two reserved bits and a 4-bit DLC. The DLC may be used to indicate the length of the data field. In the CAN 2.0 B protocol, a data field may have a length of 0 bits to 64 bits.

The CRC field may include a 15-bit CRC and a 1-bit CRC delimiter, as in the CAN 2.0 A protocol of FIG. 3A.

The acknowledgment field may include a 1-bit acknowledgment and a 1-bit acknowledgment delimiter, as in the CAN 2.0 A protocol of FIG. 3A.

FIG. 3C illustrates a structure of a CAN message for the CAN-FD protocol.

A data frame for the CAN-FD protocol is divided into a start frame (Start), an arbitration field, a control field, a data field, a CRC field, an acknowledgment field, and an end frame (End).

The arbitration field may include 11-bit identification data (ID) and a 1-bit RTR, as in the CAN 2.0 A protocol of FIG. 3A.

The control field may include a 1-bit IDE, a 1-bit extended data length (EDL), one reserved bit, a 1-bit bit rate switch (BRS), a 1-bit error state indicator (ESI), and a 4-bit DLC. The IDE may be used to indicate a CAN 2.0 A-based protocol having 11-bit identification data (ID), and may have a bit value of 0. The EDL may be used to indicate an FD protocol having an extended data field length, and may have a bit value of 1 when the data field has a length of 8 bytes or greater. The BRS may be used to switch to a high baud rate during transmission of the data field, and may have a bit value of 1. The ESI may be used to identify an error during information transmission in the CAN 2.0 A FD protocol. The DLC field may be used to indicate the length of the data field in bytes. In the CAN 2.0 A FD protocol, a data field may have a length of 0 bytes to 64 bytes.

The CRC field may include a 17-bit or 21-bit CRC and a 1-bit CRC delimiter. According to the increased length of the data field compared to the CAN 2.0 A protocol, the length of the CRC for CRC calculation also increases. The CRC delimiter may be provided to distinguish the CRC field from the acknowledgment field, and may have a bit value of 1. Although not illustrated, the CRC field may further include a stuff count (SC) bit to reflect a stuff bit during CRC calculation.

The acknowledgment field may include a 1-bit acknowledgment and a 1-bit acknowledgment delimiter, as in the CAN 2.0 A protocol of FIG. 3A.

FIG. 3D illustrates a structure of a CAN message for the Extended CAN-FD protocol.

A data frame for the Extended CAN-FD protocol is divided into a start frame (Start), an arbitration field, a control field, a data field, a CRC field, an acknowledgment field, and an end frame (End).

The arbitration field may include 11-bit first identification data (ID1), a 1-bit SRR, a 1-bit IDE, 18-bit second identification data (ID2), and a 1-bit RTR, as in the CAN 2.0 B protocol of FIG. 3B.

The control field may include a 1-bit EDL, one reserved bit, a 1-bit BRS, a 1-bit ESI, and a 4-bit DLC. Functions of the EDL, the reserved bit, the BRS, the ESI, and the DLC are the same as those of the EDL, the reserved bit, the BRS, the ESI, and the DLC in the CAN-FD protocol of FIG. 3C. In the Extended CAN-FD protocol, a data field may have a length of 8 bytes to 64 bytes.

The CRC field may include a 17-bit or 21-bit CRC and a 1-bit CRC delimiter, as in the CAN-FD protocol of FIG. 3C. The acknowledgment field may include a 1-bit acknowledgment and a 1-bit acknowledgment delimiter, as in the protocols of FIGS. 3A to 3C.

All of the CAN 2.0 A protocol, the CAN 2.0 B protocol, the CAN-FD protocol, and the Extended CAN-FD protocol illustrated in FIGS. 3A to 3D have data fields 310 to 340 included in the control fields.

In the present disclosure, a method of transmitting and receiving data by encrypting the data fields 310 to 340 of the CAN messages to enhance the security of the CAN protocols may be provided. Hereinafter, CAN messages in which the data fields 310 to 340 are encrypted will be referred to as secure CAN messages, and CAN messages in which the data fields 310 to 340 are not encrypted will be referred to as normal CAN messages.

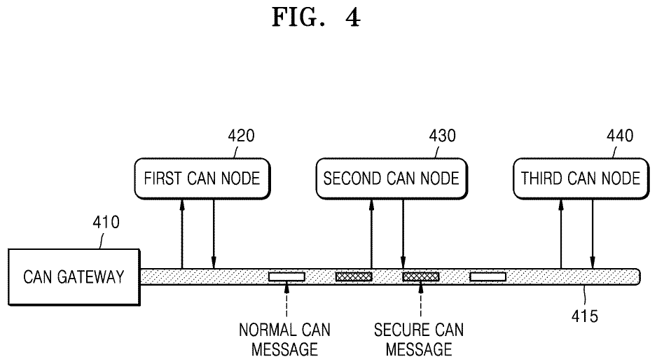

FIG. 4 is a diagram illustrating an example of transmitting CAN messages from a CAN gateway to CAN nodes, according to an embodiment.

A CAN gateway 410 and a plurality of CAN nodes 420, 430, and 440 may transmit and receive CAN messages through a CAN bus 415.

The CAN messages may include a secure CAN message and a normal CAN message. The normal CAN message refers to a message in which the data field is not encrypted as in CAN messages according to the protocols described above with reference to FIGS. 3A to 3D, and the secure CAN message refers to a message in which the data field is encrypted.

In an embodiment, among the plurality of CAN nodes 420, 430, and 440, a first CAN node equipped with a hardware security module may decrypt a secure CAN message. A second CAN node not equipped with a hardware security module cannot decrypt a secure CAN message, but because the secure CAN message and the normal CAN message have the same data structure, an error does not occur even when the second CAN node receives the secure CAN message.

A group session key may be used by the first CAN node to decrypt a CAN message. Hereinafter, transmitting a seed CAN message from the CAN gateway 410, as a preparation stage for generating a group session key, will be described.

The CAN gateway 410 may transmit a seed CAN message such that the first CAN node generates a group session key. Here, because the seed CAN message needs to be processed earlier than other CAN messages, identification data (ID) of the seed CAN message may be assigned a value less than those of the other CAN messages.

The data field of the seed CAN message may include an initial seed value, a freshness value (FV), and a message authentication code (MAC). The initial seed value is a value that is randomly generated whenever the vehicle is started. In the present disclosure, confidentiality may be enhanced by using a different initial seed value whenever the vehicle is started. The FV is a value obtained by sequentially increasing and cycling a value within a specific range. In the present disclosure, replay attacks may be prevented by introducing an FV. The MAC may be set as a MAC for the initial seed value and the FV. In a case in which there is a length limit of the data field (e.g., 8 bytes), only a part of the original MAC may be used. In the present disclosure, the integrity of the message may be verified by using the MAC.

In an embodiment, the CAN gateway 410 may encrypt the data field of the seed CAN message with a master key, and then transmit the seed CAN message to the plurality of CAN nodes 420, 430, and 440 through the CAN bus 415. Here, the master key is a key provided for each vehicle, and is a unique static value for each vehicle. The same master key may be applied to all CAN nodes in one vehicle.

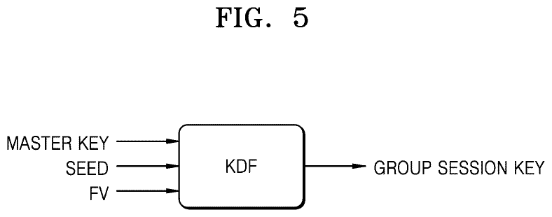

FIG. 5 is a diagram for describing a process of generating a group session key, according to an embodiment.

A first CAN node among a plurality of CAN nodes may be equipped with a hardware security module. A master key is stored in the hardware security module. For example, the first CAN node may receive a seed CAN message from a CAN gateway.

The first CAN node may generate a group session key based on the master key and the seed CAN message. The group session key may be generated by using a key derivation function (KDF).

Referring to FIG. 5, the group session key may be generated by applying the KDF to the master key, the initial seed value, the FV, and the MAC. For example, the group session key may be generated through Equation 1 below. In Equation 1, Seed may denote a value calculated through a combination of the initial seed value, the FV, and the MAC. As the KDF, PBKDF2-HMAC-SHA2 may be used, but the present disclosure is not limited thereto.

$$GroupSessionKey = KDF ( MasterKey , Seed , FV ) \qquad [ Equation 1 ]$$

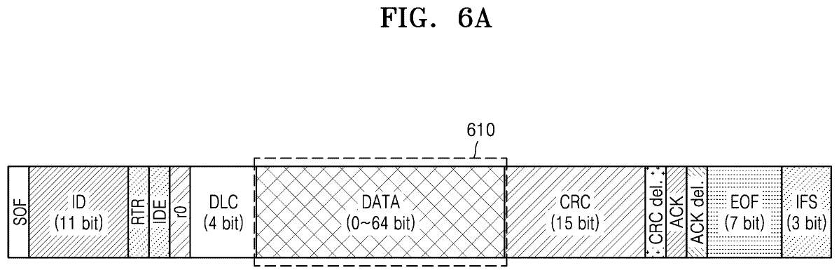

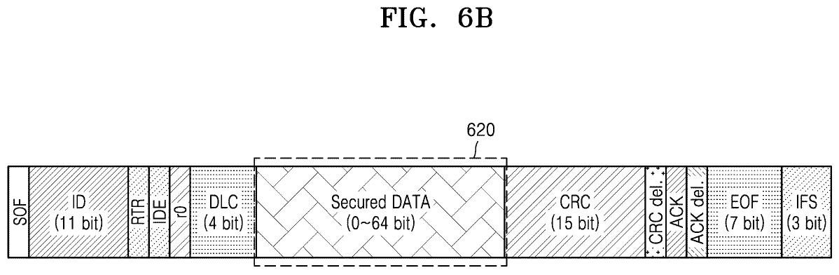

FIGS. 6A and 6B are diagrams illustrating examples of a secure CAN message in which a data field is encrypted.

FIG. 6A illustrates the structure of the CAN message for the CAN 2.0 A protocol described above with reference to FIG. 3A. The CAN message of FIG. 6A corresponds to a normal CAN message in which a data field 610 is not encrypted.

FIG. 6B illustrates a secure CAN message including an encrypted data field 620.

A CAN gateway may generate a group session key by applying a KDF to a master key provided for each vehicle. The CAN gateway may generate the group session key by applying the KDF to the master key, an initial seed value, an FV, and a MAC. For example, the group session key may be generated through Equation 1 above.

The CAN gateway may encrypt the data fields 320 to 340 of the CAN 2.0 B protocol, the CAN-FD protocol, and the Extended CAN-FD protocol illustrated in FIGS. 3B to 3D, in addition to the CAN 2.0 A protocol of FIG. 3A, and transmit the secure CAN message including the encrypted data field to the plurality of CAN nodes.

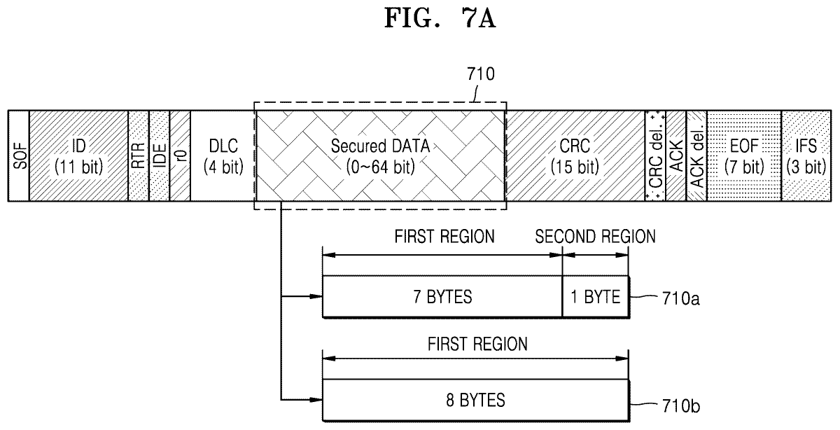

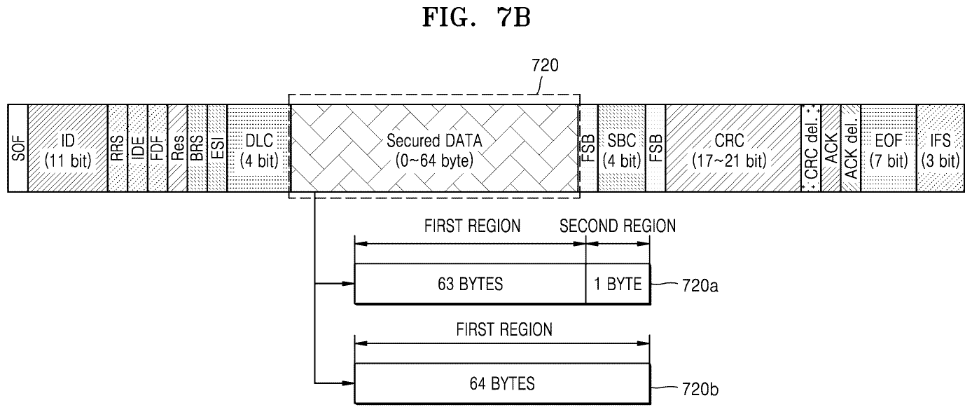

FIGS. 7A and 7B are diagrams for describing structures of encrypted data fields in secure CAN messages, according to an embodiment.

FIG. 7A illustrates a secure CAN message for the CAN 2.0A protocol. The following description may be equally applied to the CAN 2.0 B protocol.

The secure CAN message includes an encrypted data field 710. In an embodiment, the structure of the encrypted data field 710 may vary depending on a mode. In a first mode, an encrypted data field 710a may be divided into a first region for transmitting data and a second region for transmitting a MAC. In the CAN 2.0 A protocol, the encrypted data field 710 may have a maximum size of 8 bytes. To simultaneously transmit the MAC, the encrypted data field 710a may have a structure including a first region having a size of 7 bytes and a second region having a size of 1 byte.

To eliminate a data length limit of the secure CAN message at the cost of reduced security, in a second mode, the secure CAN message may carry only encrypted data without the MAC. In the second mode, an encrypted data field 710b may include only a first region for transmitting data, and the first region may have a size of 8 bytes.

FIG. 7B illustrates a secure CAN message for the CAN-FD protocol. The following description may be equally applied to the Extended CAN-FD protocol.

The secure CAN message includes an encrypted data field 720. In an embodiment, the structure of the encrypted data field 720 may vary depending on a mode. In a first mode, an encrypted data field 720a may be divided into a first region for transmitting data and a second region for transmitting a MAC. In the CAN-FD protocol, the encrypted data field 720 may have a maximum size of 64 bytes. To simultaneously transmit the MAC, the encrypted data field 720a may have a structure including a first region having a size of 63 bytes and a second region having a size of 1 byte.

To eliminate a data length limit of the secure CAN message at the cost of reduced security, in a second mode, the secure CAN message may carry only encrypted data without the MAC. In the second mode, an encrypted data field 720b may include only a first region for transmitting data, and the first region may have a size of 64 bytes.

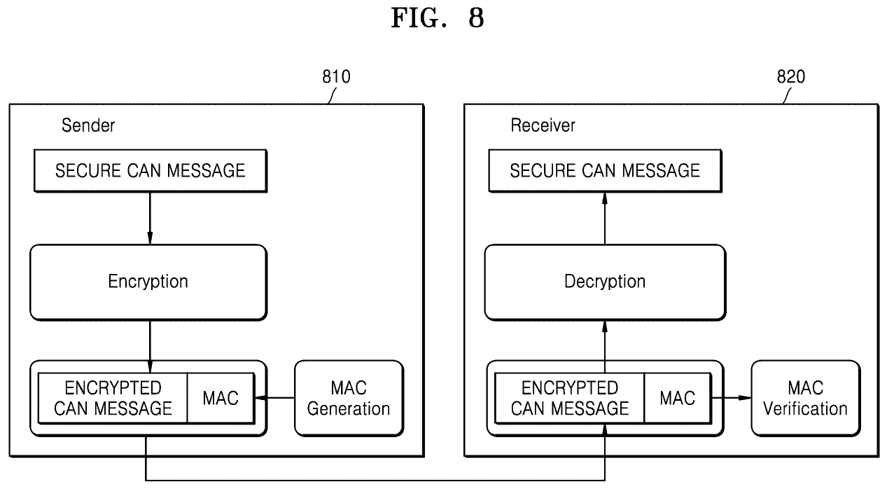

FIG. 8 is a diagram for describing a process of generating and verifying a secure CAN message, according to an embodiment.

Referring to FIG. 8, a sender may refer to a CAN gateway that encrypts and transmits a secure CAN message, and a receiver may refer to a CAN node (e.g., a CAN node equipped with a hardware security module) that receives and decrypts the secure CAN message.

Hereinafter, it is assumed that both a sender 810 and a receiver 820 have a group session key.

The sender 810 may encrypt the data field of the secure CAN message and generate a MAC, with the group session key. A process of encrypting a data field may be expressed by Equation 2 or Equation 3 below. In Equations 2 and 3, M may denote unencrypted original data, C may denote encrypted data, and Enc may denote an encryption algorithm, for example, the AES-128 algorithm.

$$C = Enc ( GroupSessionKey ) \underline{∨} M \qquad [ Equation 2 ]$$

When the performance load does not have an influence even if the group session key is encrypted once more, the sender 810 may encrypt the data field by using Equation 2, and when the performance load has an influence, the sender 810 may encrypt the data field by using Equation 3.

The MAC is a value related to the initial seed value and the FV, and may be generated through, for example, the CMAC_AES algorithm.

The encrypted data field may be divided into a first region for transmitting data and a second region for transmitting the MAC. The sender 810 may transmit the secure CAN message including the encrypted data field to the receiver 820.

The receiver 820 may first verify the integrity by using the MAC, and when the integrity is verified, decrypt the encrypted data field of the secure CAN message by using the group session key.

A process of decrypting the data field may be expressed by Equation 4 or Equation 5 below. In Equations 4 and 5, M may denote unencrypted original data, C may denote encrypted data, and Dec may denote a decryption algorithm, for example, the AES-128 algorithm.

$$C = ( GroupSessionKey ) \underline{∨} M \qquad [ Equation 3 ]$$

When the data field has been encrypted according to Equation 2 by the sender 810, the receiver 820 may decrypt the data field by using Equation 4, and when the data field has been encrypted according to Equation 3 by the sender 810, the receiver 820 may decrypt the data field by using Equation 5.

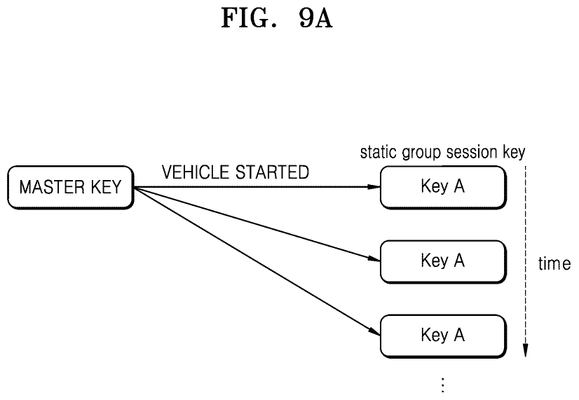

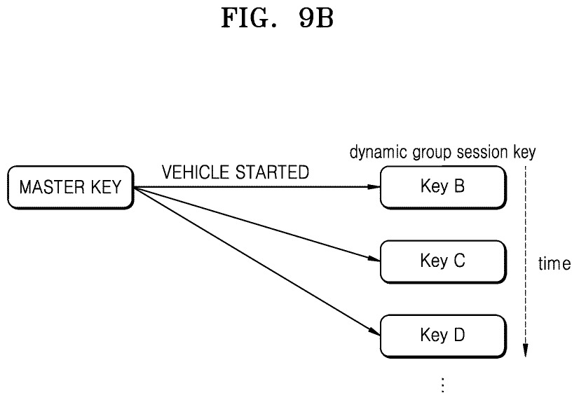

FIGS. 9A and 9B are diagrams for describing a method of using a group session key statically or dynamically, according to an embodiment.

Hereinafter, a period from when the vehicle is started until the vehicle is turned off will be referred to as a session period.

FIG. 9A illustrates a static group session key case (hereinafter, referred to as a first case). In the first case, one group session key Key A is generated from a master key of a specific vehicle, and only the generated group session key Key A is used during one session period regardless of the passage of time. In the first case, a new group session key is generated only when one session period ends and then a new session period starts.

FIG. 9B illustrates a dynamic group session key case (hereinafter, referred to as a second case). In the second case, a plurality of group session keys Key B, Key C, Key D . . . are generated from a master key of a specific vehicle, and a CAN gateway may select any one of the plurality of group session keys as a representative group session key, and then encrypt a data field of a secure CAN message. In this case, the representative group session key may be changed even during one session period. For example, a time window may be applied to one session period, such that any one of the plurality of group session keys is newly selected as the representative group session key whenever a predetermined time elapses. When the second case is applied, a CAN gateway and a plurality of CAN nodes equipped with a hardware security module may have the same number of group session keys.

In the present disclosure, security may be further enhanced by utilizing a plurality of group session keys even during one session period as in the second case.

Furthermore, referring to FIG. 2, different group session keys may be applied to the first to third CAN node groups 210, 220, and 230. In the present disclosure, to enhance security, different group session keys may be applied for respective CAN node groups during one session period.

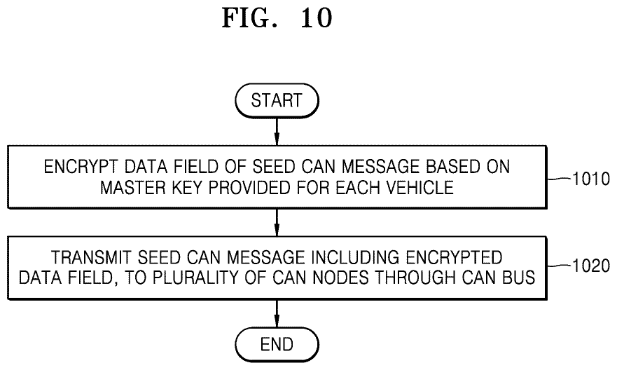

FIG. 10 is a flowchart of a method of enhancing security of a CAN, according to an embodiment.

The method of enhancing security of a CAN illustrated in FIG. 10 relates to the embodiments described above with reference to the drawings, and thus, the descriptions provided above with reference to the drawings may also be applied to the method of FIG. 10 even when omitted hereinafter.

Referring to FIG. 10, in operation 1010, a processor may encrypt a data field of a seed CAN message based on a master key provided for each vehicle.

In an embodiment, the data field of the seed CAN message may include an initial seed value, an FV, and a MAC. The initial seed value is a value that is randomly generated whenever the vehicle is started. The FV is a value obtained by sequentially increasing and cycling a value within a specific range. The MAC may be set as a MAC for the initial seed value and the FV. In a case in which there is a length limit of the data field (e.g., 8 bytes), only a part of the original MAC may be used.

In operation 1020, the processor may transmit the seed CAN message including the encrypted data field, to a plurality of CAN nodes through a CAN bus.

Here, because the seed CAN message needs to be processed earlier than other CAN messages, identification data (ID) of the seed CAN message may be assigned a value less than those of the other CAN messages.

For example, the processor may generate a group session key by applying a KDF to a master key provided for each vehicle.

The group session key may be a value that is newly generated whenever the vehicle is started. The group session key may be a value generated by applying the KDF to the master key, the initial seed value, the FV, and the MAC.

For example, the processor may encrypt the data field of the secure CAN message with the group session key.

The structure of the encrypted data field of the secure CAN message may vary depending on a mode. In a first mode, the encrypted data field of the secure CAN message may be divided into a first region for transmitting data and a second region for transmitting the MAC. Alternatively, in a second mode, the encrypted data field of the secure CAN message may include only a first region for transmitting data.

For example, the processor may transmit the secure CAN message having the encrypted data field to the plurality of CAN nodes.

In an embodiment, at least one first CAN node equipped with a hardware security module among the plurality of CAN nodes may generate a group session key based on the master key and the seed CAN message. For example, the first CAN node may receive the secure CAN message through the CAN bus, and decrypt the encrypted data field of the secure CAN message by using the generated group session key.

In an embodiment, the encrypted data field of the secure CAN message may be divided into a first region for transmitting data and a second region for transmitting a MAC. The first CAN node may verify integrity by using the MAC, and when the integrity is verified, decrypt the data of the first region by using the group session key.

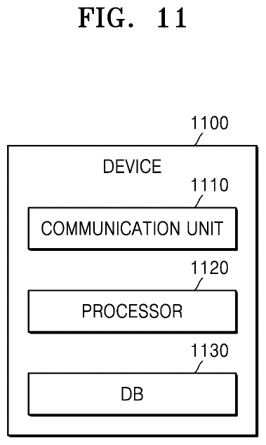

FIG. 11 is a block diagram of a CAN gateway device according to an embodiment.

Referring to FIG. 11, a CAN gateway device (hereinafter, referred to as a device) 1100 may include a communication unit 1110, a processor 1120, and a database (DB) 1130. FIG. 11 illustrates the device 1100 including only components related to an embodiment. Thus, it would be understood by those of skill in the art that other general-purpose components may be further included in addition to those illustrated in FIG. 11.

The communication unit 1110 may include one or more components for performing wired/wireless communication with an external server or an external device. For example, the communication unit 1110 may include at least one of a short-range communication unit (not shown), a mobile communication unit (not shown), and a broadcast receiver (not shown).

The DB 1130 is hardware for storing various pieces of data processed by the device 1100, and may store a program for the processor 1120 to perform processing and control.

The DB 1130 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1120 controls the overall operation of the device 1100. For example, the processor 1120 may execute programs stored in the DB 1130 to control the overall operation of an input unit (not shown), a display (not shown), the communication unit 1110, the DB 1130, and the like. The processor 1120 may execute programs stored in the DB 1130 to control the operation of the device 1100.

The processor 1120 may control at least some of the operations of the device 1100 described above with reference to FIGS. 1 to 10.

The processor 1120 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the device 1100 may be a mobile electronic device. For example, the device 1100 may be implemented as a smart phone, a tablet personal computer (PC), a PC, a smart television (TV), a personal digital assistant (PDA), a laptop computer, a media player, a navigation system, a camera-equipped device, and other mobile electronic devices. In addition, the device 1100 may be implemented as a wearable device having a communication function and a data processing function, such as a watch, glasses, a hair band, a ring, or the like.

In another embodiment, the device 1100 may be an electronic device embedded in a vehicle. For example, the device 1100 may be an electronic device that is manufactured and then inserted into a vehicle through tuning.

In another embodiment, the device 1100 may be a server located outside a vehicle. The server may be implemented as a computer device or a plurality of computer devices that provide a command, code, a file, content, a service, and the like by performing communication through a network. The server may receive data necessary for determining a movement path of a vehicle from devices mounted on the vehicle, and determine the movement path of the vehicle based on the received data.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as a commodity between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods according to the present disclosure may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as falling within the scope of the present disclosure.

According to an embodiment of the present disclosure, authentication, confidentiality, and integrity may be enhanced by adding security features to a CAN protocol.

Furthermore, according to an embodiment of the present disclosure, network communication may be performed only in authenticated CAN nodes, and security may be significantly improved through encryption and integrity verification of message data.

Furthermore, according to an embodiment of the present disclosure, security may be ensured while balancing maintenance of compatibility with an existing CAN system, and efficiency of a vehicle network.

What is claimed is:

1. A system for enhancing security of a controller area network (CAN), the system comprising:
a CAN gateway; and
a plurality of CAN nodes,
wherein the CAN gateway and the plurality of CAN nodes are configured to transmit and receive, through a CAN bus, a CAN message divided into a plurality of fields,
the CAN message includes a secure CAN message, and
a data field of the secure CAN message is an encrypted data field.

2. The system of claim 1, wherein a structure of the encrypted data field of the secure CAN message varies depending on a mode.

3. The system of claim 2, wherein, in a first mode, the encrypted data field of the secure CAN message is divided into a first region for transmitting data and a second region for transmitting a message authentication code (MAC).

4. The system of claim 2, wherein, in a second mode, the encrypted data field of the secure CAN message includes only a first region for transmitting data.

5. The system of claim 1, wherein the CAN gateway is further configured to encrypt a data field of a seed CAN message based on a master key provided for each vehicle, and transmit the seed CAN message including the encrypted data field to the plurality of CAN nodes through the CAN bus, and
the data field of the seed CAN message includes an initial seed value, a freshness value (FV), and a message authentication code (MAC).

6. The system of claim 1, wherein the CAN gateway is further configured to generate a group session key by applying a key derivation function to a master key provided for each vehicle, and encrypt the data field of the secure CAN message with the group session key, and
the group session key is newly generated whenever a vehicle is started.

7. The system of claim 6, wherein the group session key is generated by applying the key derivation function to the master key, an initial seed value, a freshness value (FV), and a message authentication code (MAC).

8. The system of claim 5, wherein at least one first CAN node equipped with a hardware security module among the plurality of CAN nodes is configured to generate a group session key based on the master key and the seed CAN message.

9. The system of claim 8, wherein the at least one first CAN node is further configured to receive the secure CAN message through the CAN bus, and decrypt the encrypted data field of the secure CAN message by using the group session key.

10. The system of claim 9, wherein the encrypted data field of the secure CAN message is divided into a first region for transmitting data and a second region for transmitting a MAC, and
the at least one first CAN node is further configured to verify integrity by using the MAC, and decrypt, in response to the integrity being verified, data of the first region by using the group session key.

11. The system of claim 6, wherein the CAN gateway is further configured to generate a plurality of group session keys by applying the key derivation function to the master key provided for each vehicle, select any one of the plurality of group session keys as a representative group session key, and encrypt the data field of the secure CAN message, and
the representative group session key is changed whenever a predetermined time elapses even before the vehicle is turned off.

12. A method of enhancing security of a controller area network (CAN), the method comprising:
encrypting a data field of a seed CAN message based on a master key provided for each vehicle; and
transmitting the seed CAN message including the encrypted data field to a plurality of CAN nodes through a CAN bus,
wherein the data field of the seed CAN message includes an initial seed value, a freshness value (FV), and a message authentication code (MAC).

13. A computer-readable recording medium having recorded thereon a program for causing a computer to execute the method of claim 12.
